(19) United States
(12) Patent Application Publication
(10) Pub. No.: US 2003/0104745 A1
(43) Pub. Date: Jun. 5, 2003

(54) Imaged nonwoven fabrics in dusting applications

(75) Inventor: Charles Keith Curtis, Benson, NC (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/206,271

(22) Filed: Jul. 26, 2002

Related U.S. Application Data
(60) Provisional application No. 60/308,331, filed on Jul. 27, 2001.

(51) Int. Cl. B32B 5/16

(52) U.S. Cl. 442/327; 442/404

(57) ABSTRACT

The present invention is directed a nonwoven fabric which is imparted with a three-dimensional image or pattern during the fabrication stage. The three-dimensional image or pattern imparted into the structure of the nonwoven fabric results in a lofty material with particulate capturing recesses or “pockets” which act to entrap and entrain dust. The three-dimensional image or pattern also results in a number of fibrous ends and loops which extend beyond the surface of the recesses or “pockets”, which in turn, improve the nonwoven fabrics ability to effectively collect particulates from the surface of the article to be cleaned or dusted. In conjunction, the recesses and the extended fibrous surface act to effectively remove fine particulates such as dust from articles such as furniture and flooring.

### TECHNICAL FIELD

The present invention relates generally to a nonwoven fabric, and specifically to a nonwoven fabric imparted with a three-dimensional pattern, which results in a material imminently suitable for application in the cleaning and dusting of articles.

### BACKGROUND OF THE INVENTION

The general use of nonwoven fabrics as a component in cleaning or dusting articles is well known in the art. Various cleaning and dusting products are commercially available which utilize a combination of topical, performance enhancing additives and/or multi-layered laminate constructions. The use of performance enhancing additives such as oils, static charge enhancers, or the like, results in a product which is often incompatible with the end-user's preferred choice of cleaning or polishing agent. Multi-layered laminate constructs, by their very nature, require multiple facing layers and interposed reinforcing layers in order to form a material with satisfactory loft and function.

A need exists for a single layer nonwoven fabric product which does not necessarily rely upon the application of oils or other pre-treatments.

### SUMMARY OF THE INVENTION

The present invention is directed a nonwoven fabric which is imparted with a three-dimensional image or pattern during the fabrication stage. The three-dimensional image or pattern imparted into the structure of the nonwoven fabric results in a lofty material with particulate capturing recesses or “pockets” which act to entrap and entrain dust. The three-dimensional image or pattern also results in a number of fibrous ends and loops which extend beyond the surface of the recesses or “pockets”, which in turn, improve the nonwoven fabrics ability to effectively collect particulates from the surface of the article to be cleaned or dusted. In conjunction, the recesses and the extended fibrous surface act to effectively remove fine particulates such as dust from articles such as furniture and flooring.

In accordance with the present invention, a method of making the nonwoven fabric embodying the present invention includes the steps of providing a precursor web comprising a fibrous matrix. In a particularly preferred form, the fibrous matrix is carded and cross-lapped to form a precursor web. It is also preferred that the precursor web be subjected to pre-entangling on a foraminous forming surface prior to imaging and patterning.

A method of making the present durable nonwoven fabric comprises the steps of providing a precursor web, which is subjected to hydroentangling. A polyester/rayon fiber blend has been found to desirably yield a nonwoven fabric suitable for subsequent use with both water and oil based cleansers or dusting agents. The precursor web is formed into an imaged and patterned nonwoven fabric by hydroentanglement on a three-dimensional image transfer device. The image transfer device defines three-dimensional elements against which the precursor web is forced during hydroentangling, whereby the fibrous constituents of the web are imaged and patterned by movement into regions between the three-dimensional elements of the transfer device.

In the preferred form, the precursor web is hydroentangled on a foraminous surface prior to hydroentangling on the image transfer device. This pre-entangling of the precursor web acts to integrate the fibrous components of the web, but does not impart imaging and patterning as can be achieved through the use of the three-dimensional image transfer device.

Other features and advantages of the present invention will become readily apparent from the following detailed description, the accompanying drawings, and the appended claims.

### BRIEF DESCRIPTION OF THE DRAWINGS

FIG. 1 is a diagrammatic view of an apparatus for manufacturing a nonwoven fabric, embodying the principles of the present invention; and

FIG. 2 is a plan view of a three-dimensional nonwoven fabric, made in accordance with the present invention. The magnification level is about 6.5×; and

FIG. 3 is a plan view of a three-dimensional nonwoven fabric, made in accordance with the present invention. The magnification level is about 15×

### DETAILED DESCRIPTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

The present invention is directed a nonwoven fabric which is imparted with a three-dimensional image or pattern during the fabrication stage. The three-dimensional image or pattern imparted into the structure of the nonwoven fabric results in two pronounced effects. First, a lofty material is formed with particulate capturing recesses or “pockets” which act to entrap and entrain dust. Second, the three-dimensional image or pattern results in a number of fibrous ends and loops which extend beyond the surface of the recesses or “pockets”, which in turn, improve the nonwoven fabrics ability to effectively collect particulates from the surface of the article to be cleaned or dusted. In conjunction, the recesses and the extended fibrous surface act to effectively remove fine particulates such as dust from articles such as furniture and flooring.

The three-dimensional nonwoven fabric is used either in sheet form by hand, or placed upon the head of a suitable mop as is readily and commercially available.

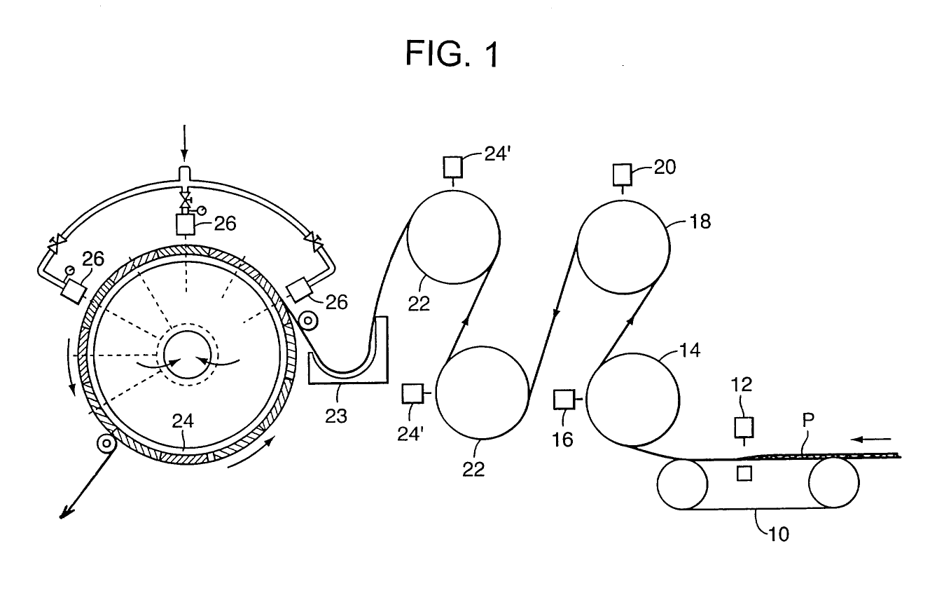

With reference to FIG. 1, therein is illustrated an apparatus for practicing the present method for forming a nonwoven fabric. The fabric is formed from a fibrous matrix which typically comprises staple length fibers. The fibrous matrix is preferably carded and cross-lapped to form a precursor web, designated P. In a current embodiment, the precursor web comprises a majority of cross-lap fibers, that is, most of the fibers of the web have been formed by cross-lapping a carded web so that the fibers are oriented at an angle relative to the machine direction of the resultant web.

FIG. 1 illustrates a hydroentangling apparatus for forming nonwoven fabrics in accordance with the present invention. The apparatus includes a foraminous forming surface in the form of belt 10 upon which the precursor web P is positioned for pre-entangling by entangling manifold 12. Pre-entangling of the precursor web, prior to imaging and patterning, is subsequently effected by movement of the web P sequentially over a drum 14 having a foraminous forming surface, with entangling manifold 16 effecting entanglement of the web. Further entanglement of the web is effected on the foraminous forming surface of a drum 18 by entanglement manifold 20, with the web subsequently passed over successive foraminous drums 20, for successive entangling treatment by entangling manifolds 24, 24′.

The entangling apparatus of FIG. 1 further includes an imaging and patterning drum 24 comprising a three-dimensional image transfer device for effecting imaging and patterning of the now-entangled precursor web. The image transfer device includes a moveable imaging surface which moves relative to a plurality of entangling manifolds 26 which act in cooperation with three-dimensional elements defined by the imaging surface of the image transfer device to effect imaging and patterning of the fabric being formed.

Hydroentanglement results in portions of the precursor web being displaced from on top of the three-dimensional surface elements of the imaging surface to form an imaged and patterned nonwoven fabric. Enhanced surface fiber extenstion is desirably achieved, thus providing improved cleaning properties for the resultant fabric.

Manufacture of a dusting nonwoven fabric embodying the principles of the present invention is initiated by providing the precursor nonwoven web preferably in the form of a blend of polyester and rayon fibers which desirably provides good cleaning chemical compatibility, yet such a blend does not degrade the static charge developed by the polyester fibers when used with a cleaning chemical. During development, it was ascertained that fabric weights on the order of 55 to 75 grams per square meter (gsm) are suitable, with a material on the order of 65 to 70 gsm material being most preferred.

### EXAMPLES

Using a forming apparatus as illustrated in FIG. 1, a nonwoven fabric was made in accordance with the present invention by providing a precursor web comprising 70 weight percent polyester staple fibers and 30 weight percent rayon staple fibers. The web had a basis weight of 69 grams per square yard (plus or minus 7%).

The fabric comprised polyester (1.5 denier) and rayon (1.6 denier). Prior to patterning and imaging of the precursor web, the web was entangled by a series of entangling manifolds such as diagrammatically illustrated in FIG. 1. FIG. 1 illustrates disposition of precursor web P on a foraminous forming surface in the form of belt 10, with the web acted upon by an entangling manifold 12. The web then passes sequentially over a drum 14 having a foraminous forming surface, for entangling by entangling manifold 16, with the web thereafter directed about the foraminous forming surface of a drum 18 for entangling by entanglement manifold 20. The web is thereafter passed over successive foraminous drums 22, with successive entangling treatment by entangling manifolds 24, 24′. In the present examples, each of the entangling manifolds included 120 micron orifices spaced at 42.3 per inch, with the manifolds operated successively at 30, 10, 30, 10, and 10 bar, with a line speed of about 40 yards per minute. A web having a width of 84 inches was employed.

The entangling apparatus of FIG. 1 further includes an imaging and patterning drum 24 comprising a three-dimensional image transfer device for effecting imaging and patterning of the now-entangled precursor web. The entangling apparatus includes a plurality of entangling manifolds 26 which act in cooperation with the three-dimensional image transfer device of drum 24 to effect patterning of the fabric. In the present example, the entangling manifolds 26 were successively operated at 90, 95, and 100 bar, at a line speed which was the same as that used during pre-entanglement.

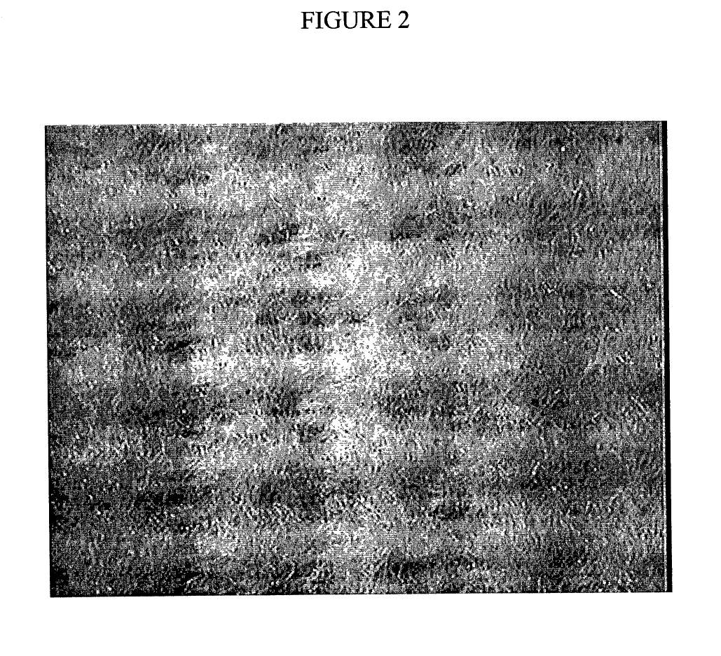

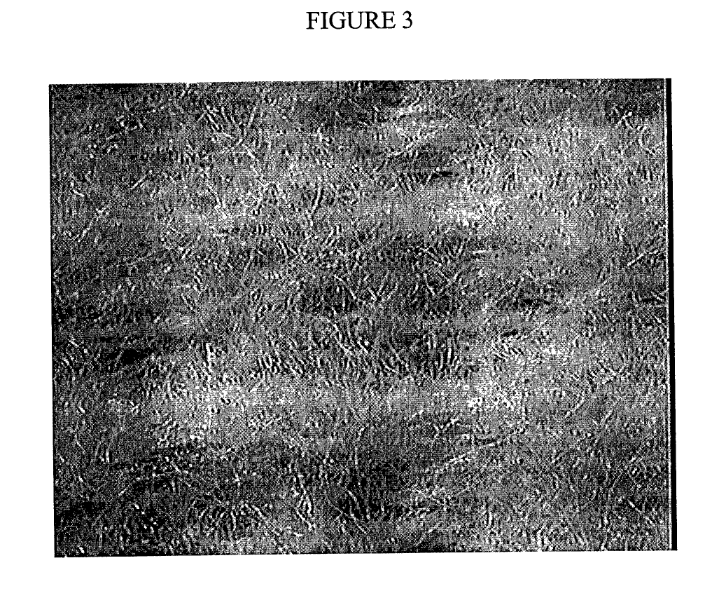

The three-dimensional imaged nonwoven fabric was configured with the dust cloth image of the present invention, as illustrated in FIGS. 2, 3, and 4. Physical testing was performed according to ASTM procedures, the data attached as TABLE 1.

The three-dimensional imaged nonwoven fabric as per the Example was then qualitatively tested against other similar treated/multi-layered dusting clothes commercially available. It was found that the single layer, untreated dusting fabrics performed equivalent or better than the commercially available clothes.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

TABLE 1
KC-301

| | | | DMDT | DMDE | DCDT | DCDE | WMDT | WMDE | WCDT | WCDE | | | |
|---|---|---|---|---|---|---|---|---|---|---|---|---|---|
| | | | ASTM | ASTM | ASTM | ASTM | ASTM | ASTM | ASTM | ASTM | Abs. Time | Abs. Cap. | Softness |
| | Full Wt. | Bulk | D 5035 | D 5035 | D 5035 | D 5035 | D 5035 | D 5035 | D 5035 | D 5035 | 1ST 10.1-95 | 1ST 10.1-95 | JJMI-5083 |
| Roll No. | (g/m²) | (mm) | (lb/in) | (%) | (lb/in) | (%) | (lb/in) | (%) | (lb/in) | (%) | (sec) | (g) | (g) |
| M1011011 | 69 | 52 | 18 | 96 | 18 | 84 | 18 | 81 | 18 | 74 | 13 | 1620 | 36 |
| | | 51 | 16 | 100 | 20 | 90 | 15 | 85 | 17 | 70 | | | 32 |
| | | 54 | 14 | 95 | 17 | 79 | 16 | 96 | 17 | 72 | | | 35 |
| | | 56 | 15 | 81 | 18 | 87 | 17 | 88 | 17 | 84 | | | 33 |
| Avg. | 69 | 53 | 16 | 93 | 18 | 85 | 16 | 87 | 17 | 75 | 13 | 1620 | 34 |
| M1011012 | 69 | 52 | 16 | 88 | 14 | 68 | 17 | 98 | 17 | 77 | 10 | 1592 | 38 |
| | | 52 | 14 | 83 | 16 | 71 | 14 | 94 | 16 | 78 | | | 31 |
| | | 51 | 15 | 83 | 17 | 74 | 14 | 90 | 17 | 79 | | | 31 |
| | | 56 | 14 | 80 | 18 | 88 | 14 | 83 | 17 | 85 | | | 35 |
| Avg. | 69 | 53 | 15 | 83 | 16 | 75 | 15 | 91 | 17 | 80 | 10 | 1592 | 34 |
| M1011013 | 70 | 51 | 18 | 92 | 13 | 75 | 17 | 90 | 14 | 66 | 13 | 1622 | 40 |
| | | 53 | 16 | 96 | 14 | 77 | 15 | 89 | 16 | 93 | | | 33 |
| | | 51 | 15 | 88 | 17 | 87 | 16 | 85 | 15 | 94 | | | 31 |
| | | 55 | 16 | 87 | 16 | 85 | 16 | 90 | 16 | 94 | | | 37 |
| Avg. | 70 | 53 | 16 | 91 | 15 | 81 | 16 | 89 | 15 | 86 | 13 | 1622 | 35 |
| Roll No. | Full Wt. | Bulk | DMDT | DMDE | DCDT | DCDE | WMDT | WMDE | WCDT | WCDE | Abs. Time | Abs. Cap. | Softness |
| M1011011 | 69 | 53 | 16 | 93 | 18 | 85 | 16 | 87 | 17 | 75 | 13 | 1620 | 34 |
| M1011012 | 69 | 53 | 15 | 83 | 16 | 75 | 15 | 91 | 17 | 80 | 10 | 1592 | 34 |
| M1011013 | 70 | 53 | 16 | 91 | 15 | 81 | 16 | 89 | 15 | 86 | 13 | 1622 | 35 |

What is claimed is:

1. A nonwoven fabric, comprising;
a prebond fibrous matrix of staple length fibers,
a three-dimensional transfer device,
hydroentangling the prebond fibrous matrix on the three-dimensional transfer device so as to impart a three-dimensional pattern into the resultant nonwoven fabric, and
the three-dimensional nonwoven fabric exhibiting the ability to entrap and entrain particulate matter from a soiled surface.

2. A nonwoven fabric of claim 1, wherein said nonwoven fabric is a dusting cloth.

3. A nonwoven fabric, comprising;
a fibrous matrix of staple length fibers,
a three-dimensional transfer device,
cross-lapping said fibrous matrix,
pre-entangling said cross-lapped fibrous matrix to form a precursor web,
advancing said precursor web onto said three-dimensional transfer device, whereby said precursor web is hydroentangled so as to impart a three-dimensional pattern into the resultant nonwoven fabric, and
the three-dimensional nonwoven fabric exhibiting the ability to entrap and entrain particulate matter from a soiled surface.

4. A nonwoven fabric of claim 3, wherein said fibrous matrix is comprised of polyester and rayon blend.
